(19) United States
(12) Patent Application Publication
(10) Pub. No.: US 2014/0013299 A1
(43) Pub. Date: Jan. 9, 2014

(54) GENERALIZATION AND/OR SPECIALIZATION OF CODE FRAGMENTS

(71) Applicants: Lucas Julien Bordeaux, Cambridge (GB); Sumit Gulwani, Bellevue, WA (US); Youssef Hamadi, Cambridge (GB); Yi Wei, Zurich (CH)

(72) Inventors: Lucas Julien Bordeaux, Cambridge (GB); Sumit Gulwani, Bellevue, WA (US); Youssef Hamadi, Cambridge (GB); Yi Wei, Zurich (CH)

(73) Assignee: MICROSOFT CORPORATION, Redmond, WA (US)

(21) Appl. No.: 13/542,975

(22) Filed: Jul. 6, 2012

(51) Int. Cl. G06F 9/44

(52) U.S. Cl. 717/106

(57) ABSTRACT

Generalization and/or specialization of code fragments is described, for example, as part of a tool for software developers. In an embodiment, a developer inserts natural language expressing a programming task into code he or she is developing in an integrated development environment; a program synthesizer obtains relevant (possibly non-compiling) code fragments for the task, merges those together to form a snippet, specializes the snippet for the context of the code and inserts the specialized snippet into the code. For example, a pair of code fragments are obtained from a search engine and are merged by discarding statements which are not common to each of the pair. In examples, pairs of code fragments are selected using search engine ranks, user input, or frequency. In embodiments, placeholders replace variable names in the merged fragments. An example takes a syntax tree of the code being developed and uses that to specialize snippets.

### BACKGROUND

Developers who are faced with a programming task often seek to re-use existing code and/or to find hints or suggestions about how to deal with a particular programming task. For example, programmers may use text books, manuals, databases, or other sources to find existing code related to the programming task. However, this is often time consuming and the programmer typically needs to be able to express the programming task in a formal, mathematical way.

Many programming tasks require a developer to interact with complex software frameworks. A software framework may expose one or more large libraries of types and functions for a wide range of programming tasks such as splitting a string, querying a database and others. Developers are not able to memorize in detail the application programming interfaces of such libraries and frequently need to access information about these from various sources whilst they are actively creating code.

Once a programmer has identified existing code that may potentially be re-used it is often difficult and time consuming for the programmer to adapt that code so that it is suitable for the particular programming task concerned. Also, errors are often introduced during the adaptation process.

The embodiments described below are not limited to implementations which solve any or all of the disadvantages of known automated programming tools.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Generalization and/or specialization of code fragments is described, for example, as part of a tool for software developers. In an embodiment, a developer inserts natural language expressing a programming task into code he or she is developing in an integrated development environment; a program synthesizer obtains relevant code fragments (which may not necessarily compile) for the task, merges and generalizes those together to form one or more snippet(s), specializes the snippet for the context of the code and inserts the specialized snippet into the code. For example, a pair of code fragments are obtained from a search engine and are merged by discarding statements which are not common to each of the pair. In examples, pairs of code fragments are selected using search engine ranks, user input, or frequency of occurrence. In embodiments, placeholders replace variable names in the merged fragments. An example takes a syntax tree of the code being developed and uses that to specialize snippets.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a program synthesizer at a personal computer for use by a programmer working with an integrated development environment;

FIG. 2 is a schematic diagram of a program synthesizer in communication with various entities via a communications network;

FIG. 3 is a flow diagram of a method at a program synthesizer;

FIG. 4 is a flow diagram of a method at a generalizer;

FIG. 5 is a flow diagram of a method at a specializer;

FIG. 6 illustrates an exemplary computing-based device in which embodiments of a program synthesizer may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

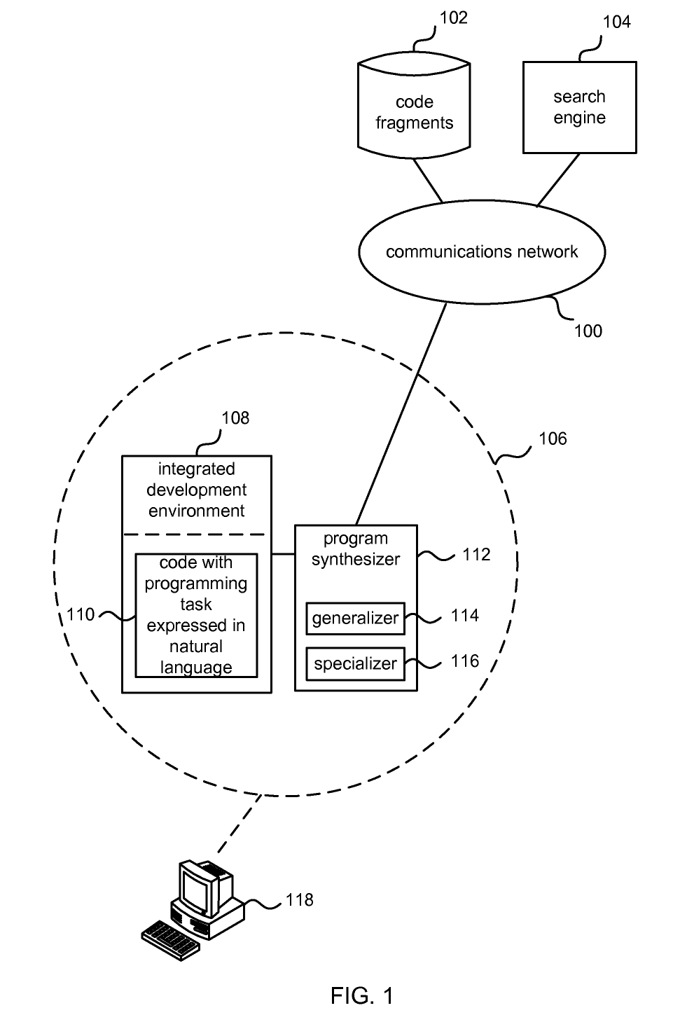

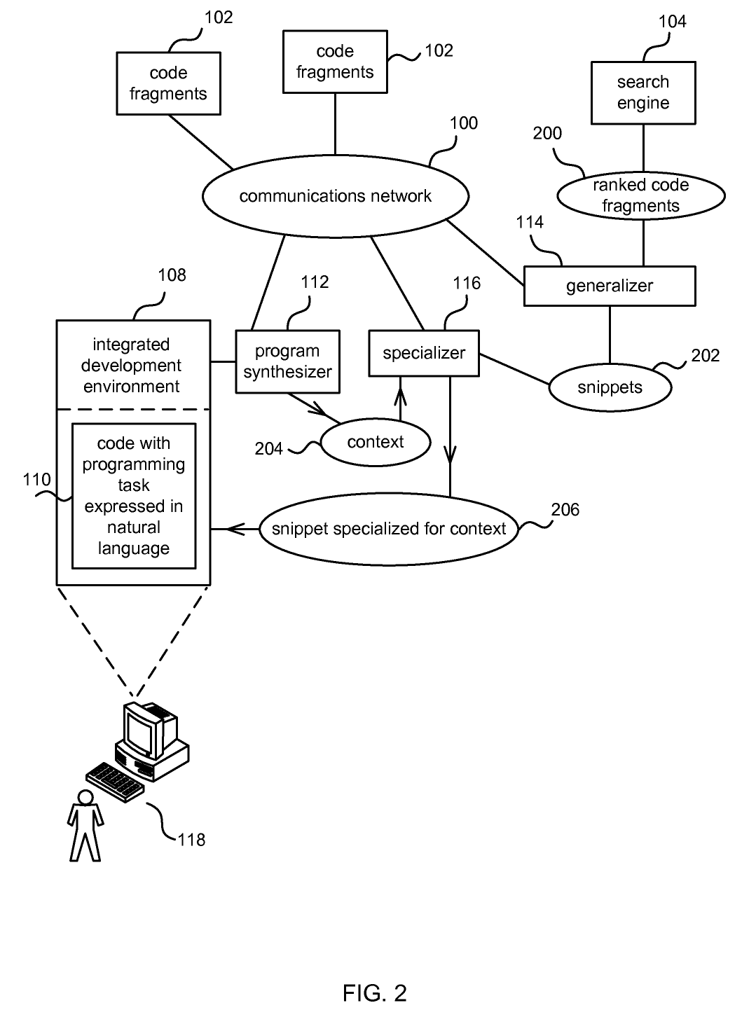

FIG. 1 is a schematic diagram of a computer-implemented program synthesizer at a personal computer 118 for use by a programmer working with an integrated development environment 108 or other software application that provides facilities to computer programmers for software development. The integrated development environment 108 and the program synthesizer 106 may be provided at the personal computer or other computing device and may or may not be integral with one another. In other examples discussed with reference to FIG. 2 the program synthesizer may be remote from the personal computer 118 or other computing device.

A programmer working with the integrated development environment 108 writes source code 110 and includes in the code, using a comment, a programming task expressed in natural language. The program synthesizer 112 is able to take the programming task expressed in natural language and find existing source code which performs the programming task. This may be achieved by querying at least one search engine 104 which has an index of items comprising relevant source code fragments 102 or in any other suitable way. The program synthesizer uses a generalizer 114 to generalize the relevant code fragments so that it is not specific to the context in which they were created. In doing so, the generalizer produces code snippets. A code snippet is a generalized fragment of code for completing a programming task. A code snippet is formed by merging (or combining) and generalizing two or more initial source code fragments and abstracting away one or more details of the initial fragments during the merging and generalizing process. Each of the initial code fragments is for completing the programming task. The program synthesizer uses a specializer 116 to adapt code snippets to make them suitable for use in the particular context of the programmer's code 110 and is then able to insert one or more specialized snippet(s) into the code 110 at the location of the comment. The comment is any type of symbol or mark that is known to the program synthesizer as indicating a programming task expressed in natural language. The comment is also known to the integrated development environment at least as indicating content which is not program code. The location of the comment in the code 110 indicates the location at which the programmer would like to insert a specialized code snippet for carrying out the programming task.

For example, a programmer inserts a comment and programming task expressed in natural language into code 110 at the integrated development environment 108. The programmer may place a cursor at a line having the comment and click a user interface element to indicate that the program synthesizer functionality is to be run. This is an example only; other types of user input may be used to indicate that the program synthesizer functionality is to be run for a selected comment. The program synthesizer may use the natural language associated with the comment as a query to a search engine 104 to obtain a ranked list of code fragments 102 that are relevant to completing the programming task. The ranked list of code fragments is used by the generalizer 114 to produce one or more code snippets. A context associated with the comment is obtained by the program synthesizer and sent to the specializer which uses that context and one or more of the code snippets to produce one or more specialized code snippets. The program synthesizer may send the specialized code snippets for display at the integrated development environment and, optionally according to user input, insert one or more of the specialized snippets into the code 110 on the basis of the location of the comment.

By using a program synthesizer in this way a programmer is able to quickly and simply retrieve code fragments, merge those into generalized code snippets and also to specialize code snippets and insert them into a particular programming context without leaving the integrated development environment. A developer does not need to carry out a complex interaction such as exiting the integrated development environment, accessing a search engine, typing in a query to the search engine, navigating through the results, loading results pages, browsing loaded pages, extracting relevant code fragments, and copying and adapting relevant code fragments back into the integrated development environment.

By merging two or more code fragments into a code snippet noise is reduced and the merging process is able to abstract away detail so that the code snippet is more abstract and is rid of irrelevant details. Code fragments found by search engines often exhibit noise such as inserted lines that fill-in some data structures with dummy values, spurious console outputs for demo purposes and other noise. By merging code fragments in a manner which abstracts away detail noise in the code fragments is reduced. Also, by merging code fragments there is increased chance of obtaining a code snippet which will carry out the programming task well. For example, one code fragment, even a top ranked one found by a search engine, rarely does the job of a specified programming task perfectly. For example, the top ranked search result may comprise several code fragments only one of which is relevant. Also, code fragments found by search engines may tend to be idiomatic in that they are commonly used and considered good practice by developers for use in a particular framework or programming language. Search engines may be arranged to find idiomatic code fragments as a result of the ranking algorithms and indexing methods they use.

When faced with a programming task a developer often tries to find which types to use and idiomatic ways of using those types. By using the program synthesizer developers are able to do this quickly and simply.

FIG. 2 is a schematic diagram of a program synthesizer in communication with various entities via a communications network 100. In contrast to FIG. 1 the program synthesizer 112 is not located at the personal computer 118 or other computing device of the developer. The program synthesizer is in communication with the generalizer 114 and the specializer 116 via a communications network in any suitable manner. That is, the generalizer 114 and the specializer 116 may be separate from one another and may be located remote of the program synthesizer 112. Only one integrated development environment 108 is illustrated in FIG. 2 for clarity although many more may be present and in communication with the program synthesizer 112 via the communications network 100.

The program synthesizer 112 is able to send a query to the search engine 104 which generates ranked code fragments 200 which are ranked in order of relevance to the query. The generalizer 114 merges two or more of the ranked code fragments 200 to produce one or more snippets 202. The specializer 116 receives a context 204 from the program synthesizer 112 and specializes one or more of the snippets 202 with respect to the context 204 to produce at least one specialized snippet 206 for the context. FIG. 2 shows one search engine 104 for clarity although more search engines may be present. Each search engine is able to access code fragments 102 from one or more sources accessible via the communications network 100 or in other ways.

Alternatively, or in addition, the functionality described herein can be performed, at least in part, by one or more hardware logic components. For example, any one or more of the program synthesizer, generalizer and specializer may be implemented, at least in part, using hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs).

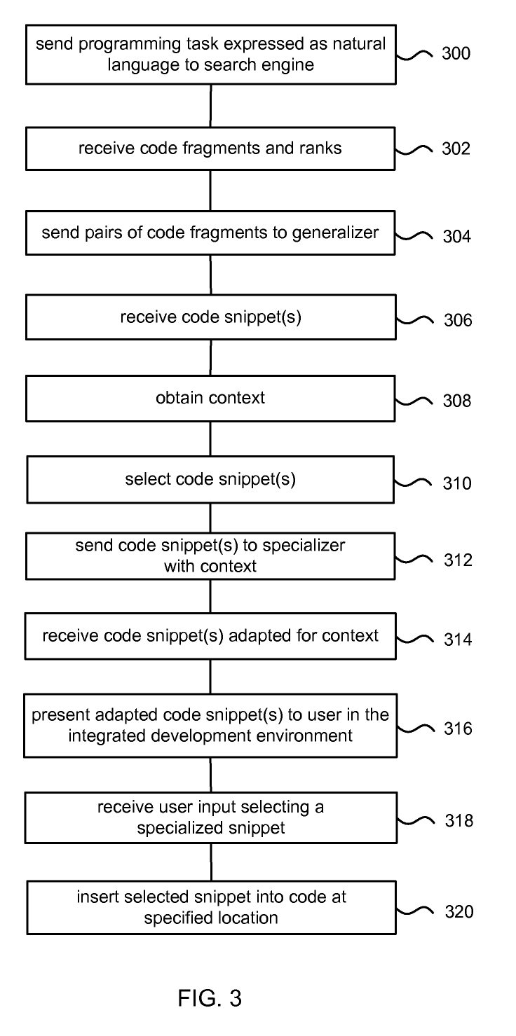

FIG. 3 is a flow diagram of a method at a program synthesizer. The program synthesizer receives or accesses a programming task expressed in natural language. For example, a user selects a comment in code at an integrated development environment. The program synthesizer extracts the natural language associated with the comment and uses that to form a query. In the example code given below the comment is “//?” and the programming task expressed as natural language is “read the source line by line”. In this example, the code is written in C# and is understood in the conventions of that language. However, this is an example only; other programming languages may be used.

Example of initial code at integrated development environment:

Public static int WordCount(Stream source)
{
Int result = 0;
//? Read the source line by line
Return result;
}

The program synthesizer sends 300 the query (such as “read source line by line”) to a search engine and receives 302 a list of code fragments ranked in terms of relevance to the query. The program synthesizer sends 304 one or more pairs of the code fragments to the generalizer. For example, it may send all the code fragments identified by the search engine, or one or more pairs of the identified code fragments selected according to the ranks, according to frequency of occurrence in the results list, according to user input, or in any other way. In some examples, a user may be able to view the code fragments and select those to be used by the generalizer.

The program synthesizer receives one or more code snippets 306 from the generalizer and obtains 308 a context from the integrated development environment. For example, the program synthesizer accesses a syntax tree of the code at the integrated development environment and finds a location of the comment in the syntax tree. The syntax tree and location may be used as a context to send to the specializer. A syntax tree is a tree representation of syntactic structure of source code written in a programming language. A root node of the tree may represent a statement sequence, internal nodes of the tree may represent constructs such as conditions or other expressions and leaves of the tree may represent variable names or values of constants.

The program synthesizer selects 310 one or more of the code snippets and sends 312 one or more of the selected code snippets to the specializer with the context. The program synthesizer receives 314 one or more code snippets which have been specialized for the context. It optionally presents 316 the specialized code snippets in the integrated development environment. For example, by presenting a pop up display over the comment at a graphical user interface displaying the code. The user may be able to toggle the contents of the pop up display in the case that two or more specialized code snippets are available for a given comment. User input is received 318 selecting a specialized snippet and the program synthesizer inserts the selected specialized snippet into the code according to the location of the comment.

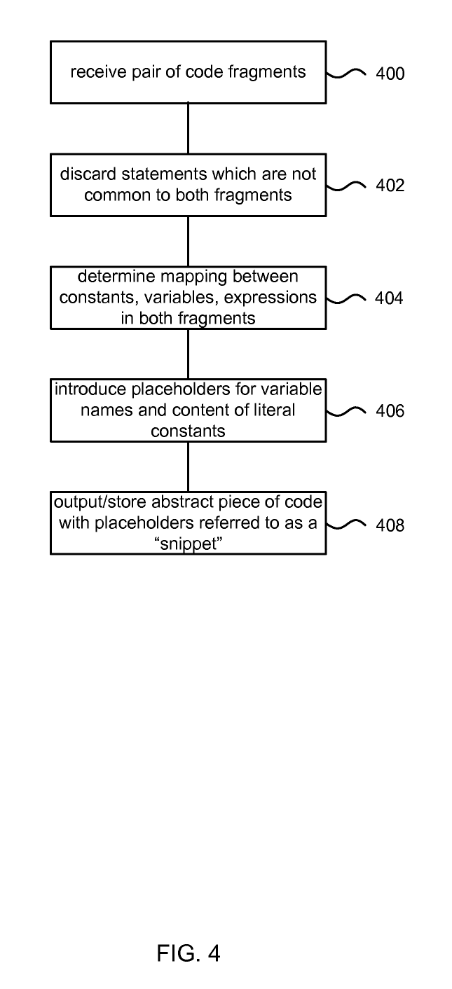

FIG. 4 is a flow diagram of a method at a generalizer. The generalizer receives 400 a pair of code fragments and merges them into a single snippet. The merging process comprises discarding 402 statements which are not common to both fragments and determining 404 a mapping between constants, variables and expressions in both fragments. The generalizer also introduces 406 placeholders for variable names and for the content of literal constants. The generalizer outputs and/or stores 408 the resulting abstract piece of code with placeholders. This abstract piece of code with placeholders is referred to as a “snippet”.

More detail about the method of FIG. 4 is now given with reference to an example where the programming task expressed in natural language is “in C#, how do I read the source line by line?”. This is an example only and other programming tasks may be used.

A pair of code fragments received by the generalizer at step 400 of FIG. 4 may be as follows:

```
CODE FRAGMENT 1
string filePath = @“C:\Example\source.txt”;
string line;
If(File.Exists( filePath ))
{
using(StreamReader file = new StreamReader( filePath ))
        {
        while ((line = file.ReadLine( )) != null)
            {
            Console.WriteLine( line );
            }
      }
}
Console.ReadLine( );
CODE FRAGMENT 2:
int count = 0;
using (var reader = new StreamReader(“your source file here”))
{
      string 1;
      while ((1 = reader.ReadLine( )) != null)
      {
          ++count;
      }
}
```

The merging process comprises discarding 402 statements which are not common to both fragments. In the example of code fragments 1 and 2 above, fragment 2 declares an integer variable called “count” that is without a counterpart in fragment 1 and so is discarded.

The merging process comprises determining 404 a mapping between constants, variables and expressions in both fragments. For example, the variable “line” in fragment 1 above is mapped to the variable “L” in fragment 2 above because the method calls that these variables are an argument of, and a target to, are isomorphic.

Placeholders may be introduced 406. This enables the names of variables and the content of literal constants to be abstracted away by introducing fresh variable names referred to as “placeholders”. In the example code fragments 1 and 2 above a placeholder called “$2” may be introduced instead of “line” and “L”. The placeholder names are selected so as not to interfere with variable names used elsewhere in the code at the integrated development environment.

An example snippet created by the generalizer from code fragments 1 and 2 is:

```
CODE SNIPPET produced from code fragments 1 and 2
string $1;
string $2;
using(var $3 = new StreamReader($1))
{
      while(($2 = $3.ReadLine( )) != null)
      {
      }
}
```

It can be seen that statements which are not common to fragments 1 and 2 have been discarded and that the variable “line” in fragments 1 has been mapped to the variable “L” in fragment 2 and replaced by the placeholder “$2”.

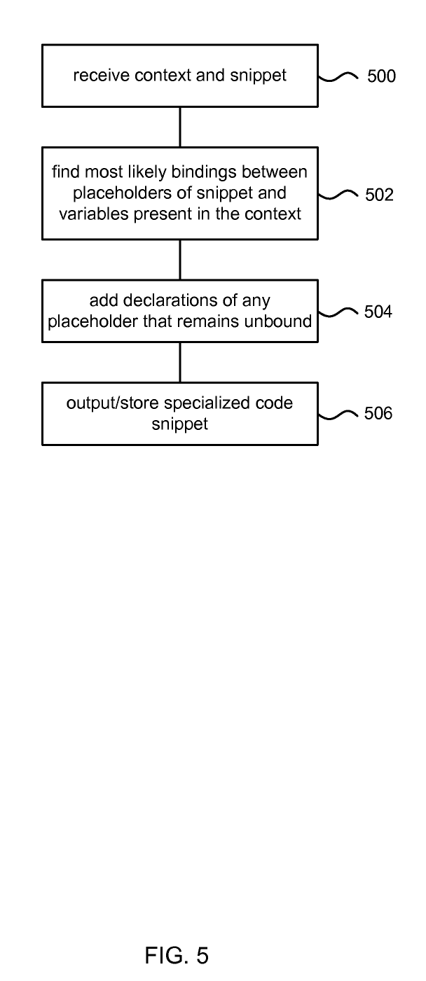

More detail about the method of FIG. 5 is now given with reference to the same example as discussed above with reference to FIG. 4. This is an example only and other programming tasks may be used. The specializer receives 500 a context and the code snippet given above produced from code fragments 1 and 2. The context may comprise a syntax tree and the location of the comment “//?” in the syntax tree of the example of initial code at the integrated development environment given above with reference to FIG. 3. The generalizer finds 502 a most likely binding between placeholders of the snippet and variables of the initial code. In this example, $1 of the code snippet is bound to “source” of the initial code context. The specializer also adds 504 declarations of any placeholder that remains unbound. For example, the placeholder $2 in the snippet becomes S2 in the specialized code fragment:

Example of specialization of the code snippet into the initial code:

```
public static int WordCount(Stream source)
    {
          int result = 0;
          string S2;
          using (var S3 = new StreamReader(source))
          {
                while((S2 = S3.ReadLine( )) != null)
                {
                }
          }
return result;
    }
```

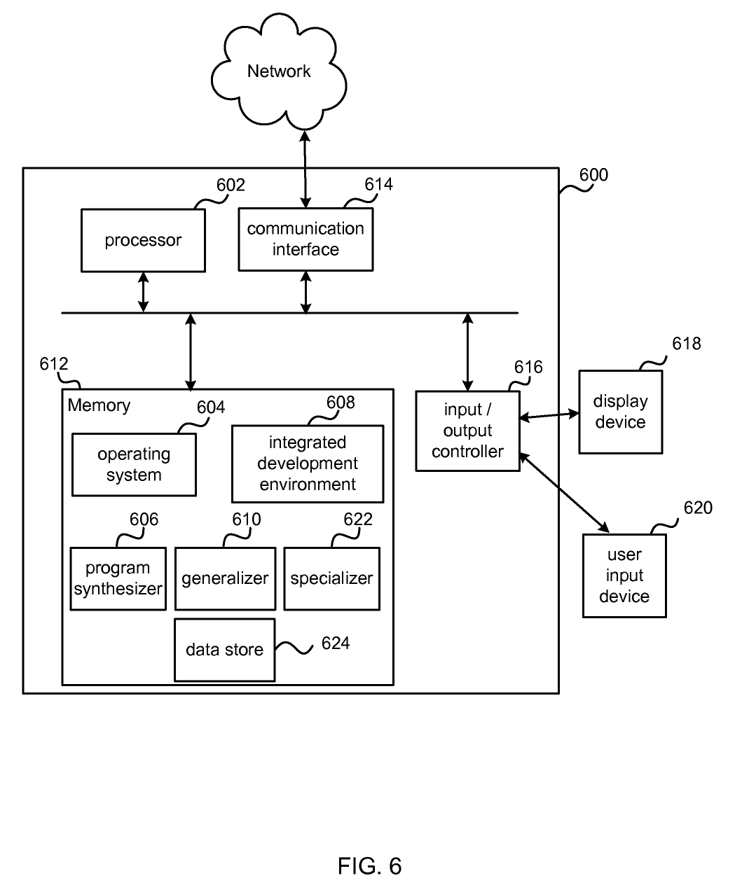

FIG. 6 illustrates various components of an exemplary computing-based device 600 which may be implemented as any form of a computing and/or electronic device, and in which embodiments of a program synthesizer, generalizer or specializer may be implemented.

Computing-based device 600 comprises one or more processors 602 which may be microprocessors, controllers or any other suitable type of processors for processing computer executable instructions to control the operation of the device in order to generalize and/or specialize code fragments. In some examples, for example where a system on a chip architecture is used, the processors 602 may include one or more fixed function blocks (also referred to as accelerators) which implement a part of the method of any of FIGS. 3, 4 and 5 in hardware (rather than software or firmware). Platform software comprising an operating system 604 or any other suitable platform software may be provided at the computing-based device to enable application software to be executed on the device. For example, the computing-based device may comprise an integrated development environment 608, a program synthesizer 606 arranged to carry out the method of FIG. 3, a generalizer 610 arranged to carry out the method of FIG. 4 and a specializer 622 arranged to carry out the method of FIG. 5. The computing-based device may also comprise a data store 624 to store code snippets, search results, search result ranks, user preferences, specialized code snippets and other data.

The computer executable instructions may be provided using any computer-readable media that is accessible by computing based device 600. Computer-readable media may include, for example, computer storage media such as memory 600 and communications media. Computer storage media, such as memory 600, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 612) is shown within the computing-based device 600 it will be appreciated that the storage may be distributed or located remotely and accessed via a network or other communication link (e.g. using communication interface 614).

The computing-based device 600 also comprises an input/output controller 616 arranged to output display information to a display device 618 which may be separate from or integral to the computing-based device 600. The display information may provide a graphical user interface. The input/output controller 616 is also arranged to receive and process input from one or more devices, such as a user input device 620 (e.g. a mouse, keyboard, camera, microphone or other sensor). In some examples the user input device 620 may detect voice input, user gestures or other user actions and may provide a natural user interface (NUI). This user input may be used to input comments, programming tasks expressed as natural language, to select specialized code snippets, and for other purposes including controlling any of a program synthesizer, generalizer and specializer. In an embodiment the display device 618 may also act as the user input device 620 if it is a touch sensitive display device. The input/output controller 616 may also output data to devices other than the display device, e.g. a locally connected printing device.

The input/output controller 616, display device 618 and optionally the user input device 620 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method comprising:
obtaining natural language expressing a programming task;
obtaining a context comprising details of source code in which the natural language is located;
at a processor, using the natural language to obtain a plurality of source code fragments related to the programming task;
receiving a code snippet from a generalizer, the code snippet having been formed by merging at least one pair of the source code fragments into a single code snippet and abstracting away one or more details of the merged source code fragments; and
sending the context and the code snippet to a specializer and receiving from the specializer, a specialized code snippet which is the code snippet specialized according to the context.

2. A method as claimed in claim 1 comprising obtaining the context by accessing a syntax tree of the source code in which the natural language is located and assessing the location of the natural language with respect to the syntax tree.

3. A method as claimed in claim 1 comprising using the natural language to obtain the plurality of source code fragments by sending the natural language as a query to at least one search engine and obtaining a list of search results and ranks of those search results.

4. A method as claimed in claim 3 comprising selecting at least one pair of source code fragments from the plurality of source code fragments on the basis of any one or more of: user input, search result ranks, frequency of occurrence in the list of search results; and sending the selected at least one pair of source code fragments to the generalizer.

5. A method as claimed in claim 1 the code snippet having been formed by introducing placeholders for variable names and for the content of literal constants.

6. A method as claimed in claim 1 the code snippet having been formed by determining a mapping between constants, variables and expressions in the at least one pair of code fragments.

7. A method as claimed in claim 1 comprising sending a plurality of code snippets to the specializer and receiving a plurality of specialized code snippets each having been specialized according to the context; and presenting the specialized code snippets at an integrated development environment being used to create the source code.

8. A method as claimed in claim 7 comprising receiving user input selecting one of the specialized code snippets and inserting the specialized code snippet into the source code in the integrated development environment according to the location of the natural language.

9. A method as claimed in claim 1 the specialized code snippet having been formed by finding bindings between placeholders of the code snippet and variables present in the source code in which the natural language is located.

10. A method as claimed in claim 9 the specialized code snippet having added declarations for any unbounded placeholders.

11. A method comprising:
receiving at least one pair of source code fragments related to a programming task;
merging the pair of source code fragments into a single code snippet by determining a mapping between constants, variables and expressions in both fragments and discarding statements which are not common to both fragments.

12. A method as claimed in claim 11 comprising introducing placeholders in the code snippet for variable names and for the content of literal constants.

13. A program synthesizer comprising:
a processor arranged to obtain natural language expressing a programming task and to obtain a context comprising details of source code in which the natural language is located;
the processor being arranged to use the natural language to obtain a plurality of source code fragments related to the programming task;
a generalizer arranged to form a code snippet by merging at least one pair of the source code fragments into a single code snippet and abstracting away one or more details of the merged source code fragments; and
a specializer arranged to specialize the code snippet specialized according to the context.

14. A program synthesizer as claimed in claim 13 the processor arranged to obtain the context by accessing a syntax tree of the source code in which the natural language is located and assessing the location of the natural language with respect to the syntax tree.

15. A program synthesizer as claimed in claim 13 the processor arranged to use the natural language to obtain the plurality of source code fragments by sending the natural language as a query to at least one search engine and obtaining a list of search results and ranks of those search results.

16. A program synthesizer as claimed in claim 13 the processor arranged to select at least one pair of source code fragments from the plurality of source code fragments on the basis of any one or more of: user input, search result ranks, frequency of occurrence in the list of search results; and to send the selected at least one pair of source code fragments to the generalizer.

17. A program synthesizer as claimed in claim 13 where the generalizer is arranged to form the code snippet by introducing placeholders for variable names and for the content of literal constants.

18. A program synthesizer as claimed in claim 13 the generalizer being arranged to form the code snippet by determining a mapping between constants, variables and expressions in the at least one pair of code fragments.

19. A program synthesizer as claimed in claim 13 the generalizer being at least partially implemented using hardware logic selected from any one or more of: a field-programmable gate array, a program-specific integrated circuit, a program-specific standard product, a system-on-a-chip, a complex programmable logic device.

20. A program synthesizer as claimed in claim 13 the specializer being at least partially implemented using hardware logic selected from any one or more of: a field-programmable gate array, a program-specific integrated circuit, a program-specific standard product, a system-on-a-chip, a complex programmable logic device.
